(19) United States
(12) Patent Application Publication
(10) Pub. No.: US 2026/0354398 A1
(43) Pub. Date: Nov. 12, 2026

(54) SMOKER

(71) Applicant: Dongguan Yuanmange Electronics Co., Ltd., Dongguan (CN)

(72) Inventor: QIANKUN ZHAO, Nanchong (CN)

(21) Appl. No.: 19/218,575

(22) Filed: May 26, 2025

(30) Foreign Application Priority Data
May 9, 2025 (CN) 202520913608.7

(51) Int. Cl. A23B 4/052; C12G 3/07

(52) U.S. Cl. CPC A23B 4/052; C12G 3/07

(57) ABSTRACT

The present invention provides a smoker, including a body, wherein the smoker further includes a mesh bag disposed in the body, a heating rod mounted in the mesh bag, a holding mesh mounted in the mesh bag and matched with the heating rod for use and a fan mounted on a side, away from the holding mesh, of the mesh bag; and a plurality of vent holes are formed in a side, close to the fan, of the body. During use, the body is placed above a cup holding a liquid, fruit woods and other smoking materials are placed, and the smoking materials are heated by the heating rod to produce smoke, and the smoke is blown to the inside of the cup via the vent holes by means of the fan, thereby smoking the liquid in the cup, which can increase the flavor of drinks or wines.

### CROSS-REFERENCE TO RELATED APPLICATIONS

This application claims priority to Chinese Patent Application No. 202520913608.7, filed on May 9, 2025, which is hereby incorporated by reference in its entirety.

### TECHNICAL FIELD

Embodiments of the present invention relate to the technical field of smokers, in particular to a smoker.

### BACKGROUND

Smokers are mainly used to increase smoky flavors of containers or liquids or food in the containers, and they are designed to be varied. By combusting woods of different trees, different woody aroma is obtained. For example, smoke produced by combusting apple woods has the unique aroma of the apple woods, and thus, unique aroma and different flavors can be provided.

However, existing smokers are usually larger, which is not beneficial for users to carry or use the smokers.

### SUMMARY

For solving the technical problem that an existing smoker is larger, the present invention provides a smoker.

The present invention provides a smoker, including a body, wherein the smoker further includes a body, wherein the smoker further includes a metal combustion chamber disposed in the body, a heating rod mounted in the metal combustion chamber, a holding mesh mounted in the metal combustion chamber and matched with the heating rod for use and a fan mounted on a side, away from the holding mesh, of the metal combustion chamber; and a plurality of vent holes are formed in a side, close to the fan, of the body.

Further, the body is provided with a face plate, and the face plate is provided with a mounting hole matched with the metal combustion chamber for use.

Further, the body is further provided with a cover plate matched with the metal combustion chamber for use.

Further, a control panel for controlling a working state of the smoker and a power module for supplying power for the smoker are further disposed in the body, and the face plate is provided with a button connected with the control panel and used for controlling the fan and the heating rod to be switched on or off.

Further, an LED lamp is further mounted on a side, close to heat dissipation holes, of the fan.

Further, a fixing portion for fixing the metal combustion chamber and the fan is disposed in the body, smoking channels are disposed in the fixing portion, and an accommodating cavity is formed in a space between the fixing portion and the body.

Further, the holding mesh is provided with a through hole for inserting the heating rod.

Further, the fixing portion is provided with a partition plate between the metal combustion chamber and the fan, and a gap communicating with the smoking channels on two sides of the partition plate is disposed around the partition plate.

The present invention has the beneficial effects that when the present invention is used, the body is placed above a container, fruit woods and other smoking materials are placed in the holding mesh, then, the holding mesh is mounted in the metal combustion chamber, at the time, the heating rod is inserted to the holding mesh and is in contact with the smoking materials, and the smoking materials are heated by the heating rod, so that the smoking materials produce smoke; the smoke is blown to the inside of the container via the vent holes by means of the fan, thereby smoking the container and a liquid in the container, which can effectively increase the flavor of drinks or wines; and meanwhile, the present invention is simple in structure, smaller in volume and convenient to carry and use.

### BRIEF DESCRIPTION OF DRAWINGS

FIG. 1 is a perspective view of an embodiment of a smoker in the present invention;

FIG. 2 is a perspective view of an embodiment of a smoker in the present invention with a cover plate being removed;

FIG. 3 is a perspective view of an embodiment of a smoker in the present invention with a holding mesh being removed;

FIG. 4 is a perspective view of an embodiment of a smoker in the present invention with a face plate being removed;

FIG. 5 is a perspective view of another embodiment of a smoker in the present invention;

FIG. 6 is a sectional view of an embodiment of a smoker in the present invention; and

FIG. 7 is a perspective view of a fixing portion of an embodiment of a smoker in the present invention.

### DESCRIPTION OF EMBODIMENTS

Embodiments of the present invention will be described in detail below, and examples of the embodiments are shown in the accompanying drawings, wherein the same or similar numerals throughout indicate the same or similar elements or elements with same or similar functions. The embodiments described below with reference to the accompanying drawings are exemplary, and are intended to explain the present invention, rather than to be understood as limitations on the present invention.

The present invention will be further described in detail below with specific implementations in conjunction with the accompanying drawings.

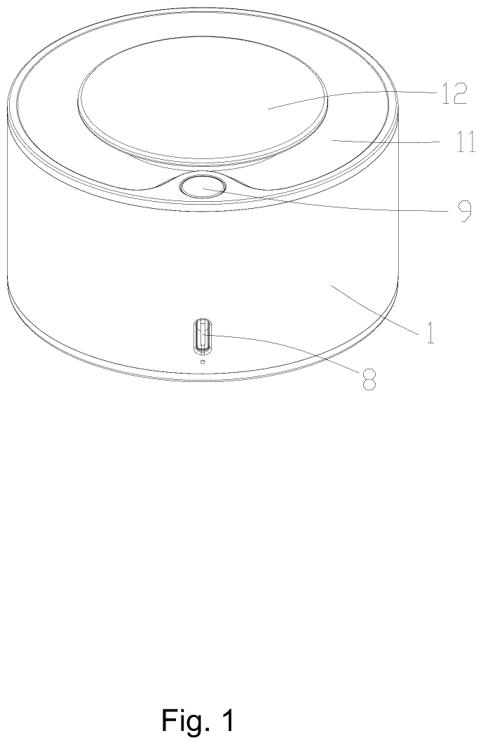

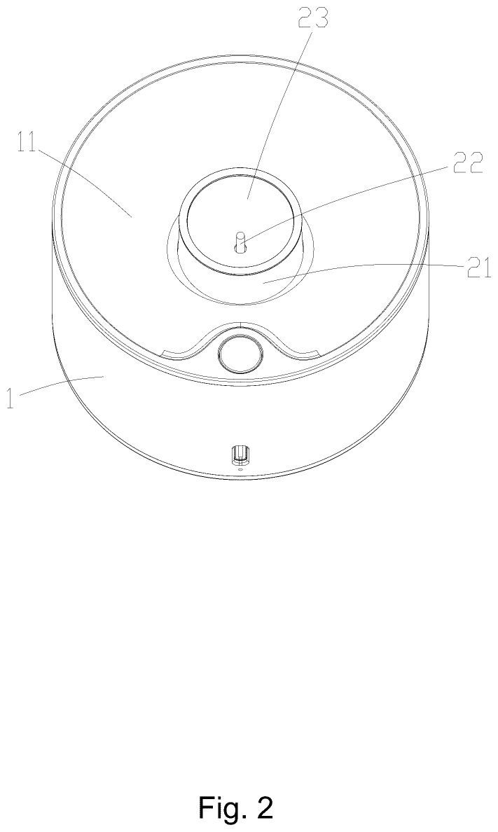

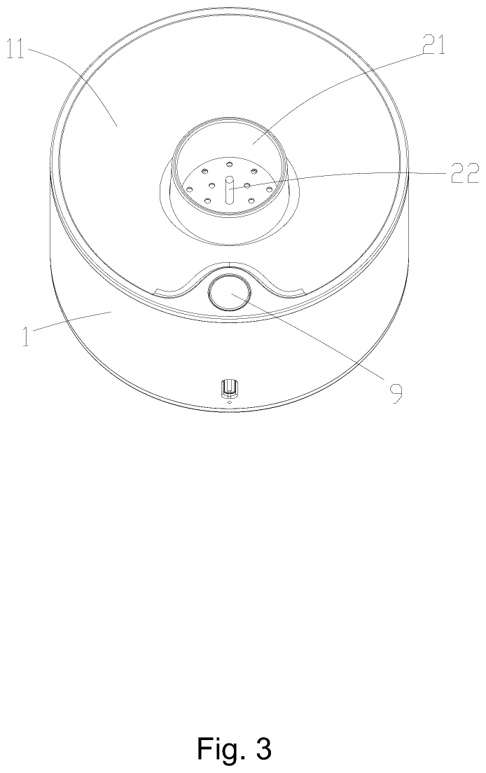

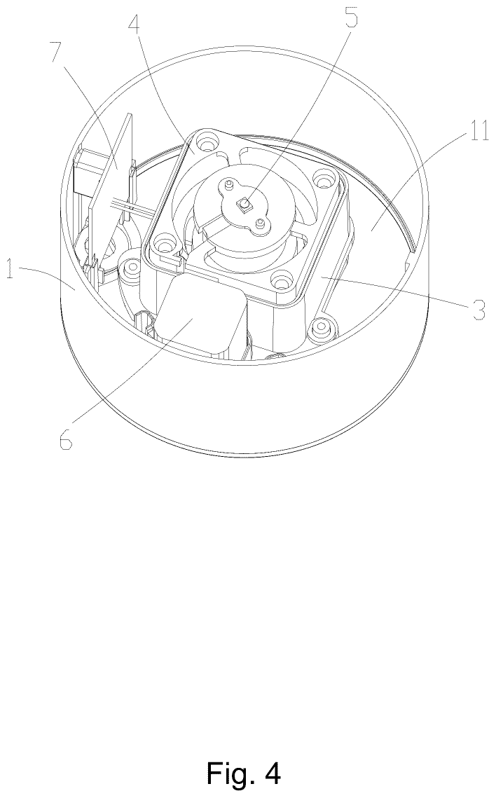

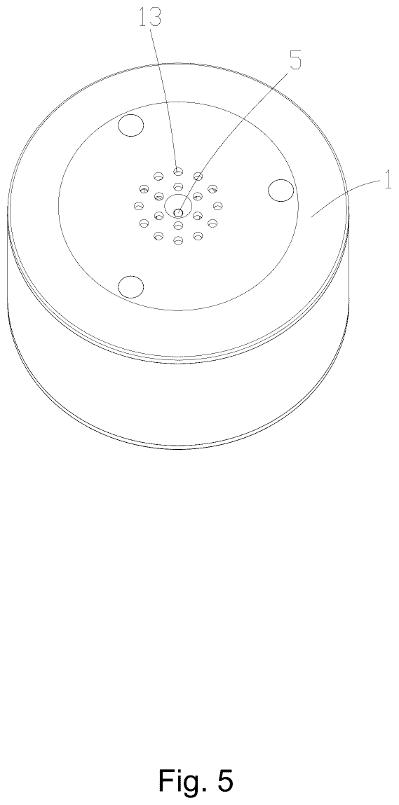

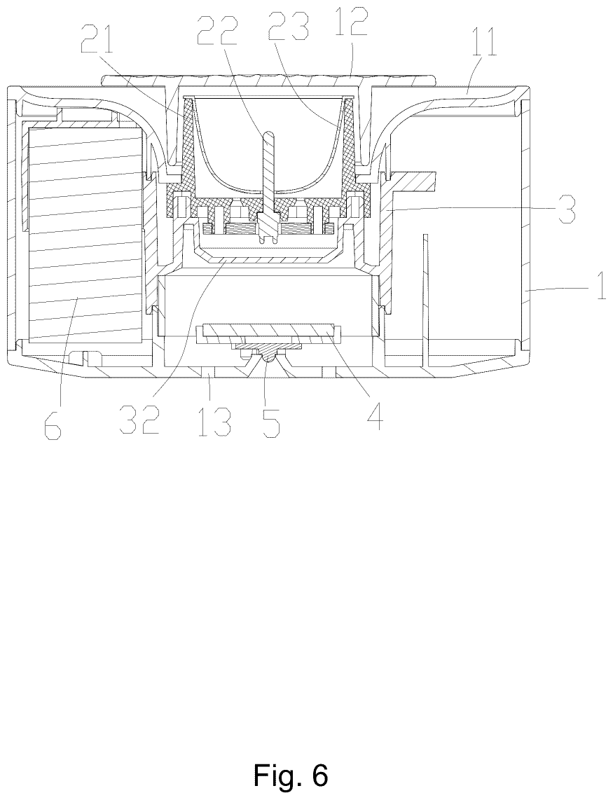

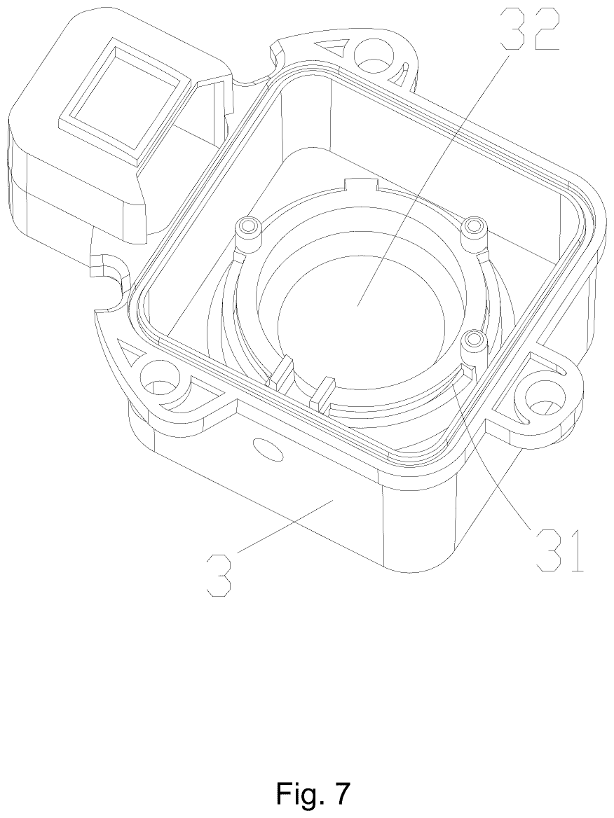

As shown in FIG. 1 to FIG. 7, the present invention provides a smoker, including a body 1, wherein the smoker further includes a metal combustion chamber 21 disposed in the body 1, a heating rod 22 mounted in the metal combustion chamber 21, a holding mesh 23 mounted in the metal combustion chamber 21 and matched with the heating rod 22 for use and a fan 4 mounted on a side, away from the holding mesh 23, of the metal combustion chamber 21; and a plurality of vent holes 13 are formed in a side, close to the fan 4, of the body 1.

When the present invention is used, the body 1 is placed above a container, fruit woods and other smoking materials are placed in the holding mesh 23, then, the holding mesh 23 is mounted in the metal combustion chamber 21, at the time, the heating rod 22 is inserted to the holding mesh 23 and is in contact with the smoking materials, and the smoking materials are heated by the heating rod 22, so that the smoking materials produce smoke; the smoke is blown to the inside of the container via the vent holes 13 by means of the fan 4, thereby smoking the container and a liquid in the container, which can effectively increase the flavor of drinks or wines; and meanwhile, the present invention is simple in structure, smaller in volume and convenient to carry and use. Specifically, the bottom of the metal combustion chamber 21 and the holding mesh 23 are both provided with a plurality of smoke through holes.

In an optional embodiment, the body 1 is provided with a face plate 11, and the face plate 11 is provided with a mounting hole matched with the metal combustion chamber 21 for use. Specifically, the body 1 is further provided with a cover plate 12 matched with the metal combustion chamber 21 for use.

In the present embodiment, the mounting hole is disposed so that an open end of the metal combustion chamber 21 can be disposed at the mounting hole, which facilitates mounting and dismounting the holding mesh 23 and the metal combustion chamber 21; and by disposing the cover plate 12 and matching the cover plate 12 with the face plate 11, the holding mesh 23 is closed in the metal combustion chamber 21, so that touching the heating rod 22, the holding mesh 23 and the fruit woods and other smoking materials placed in the holding mesh 23 by mistake during heating is avoided, and the safety performance is effectively improved.

In an optional embodiment, a control panel 7 for controlling a working state of the smoker and a power module for supplying power for the smoker are further disposed in the body 1, and the face plate 11 is provided with a button 9 connected with the control panel 7 and used for controlling the fan 4 and the heating rod 22 to be switched on or off.

In the present embodiment, the fan 4, the heating rod and the power module 6 are all connected with the control panel 7, and by means of the button 9, the heating rod and the fan 4 can be controlled to be switched on or off, and thus, the working state of the smoker is controlled; and specifically, the control panel 7 is further provided with a charging interface 8 which facilitates charging the power module 6.

In an optional embodiment, an LED lamp 5 is further mounted on a side, close to heat dissipation holes, of the fan 4.

In the present embodiment, the LED lamp 5 is connected with the control panel 7, and by disposing the LED lamp 5, the beauty of the smoker during use can be effectively increased, and meanwhile, the working state of the smoker can be effectively observed.

In an optional embodiment, a fixing portion 3 for fixing the metal combustion chamber 21 and the fan 4 is disposed in the body 1, smoking channels are disposed in the fixing portion 3, and an accommodating cavity is formed in a space between the fixing portion 3 and the body 1. Specifically, the fixing portion 3 is provided with a partition plate 32 between the metal combustion chamber 21 and the fan 4, and a gap 31 communicating with the smoking channels on two sides of the partition plate 32 is disposed around the partition plate 32.

In the present embodiment, by disposing the fixing portion 3, the metal combustion chamber 21, the holding mesh 23 and the heating rod 22 can be disposed alone, and the accommodating cavity is disposed to fix and accommodate other parts, so that the holding mesh 23 and the heating rod 22 are isolated from the control panel 7 and the power module, and then, the safety and the use performance of the control panel 7 and the power module are effectively guaranteed. In addition, by disposing the smoking channels, it is convenient for the fan 4 to blow smoke to food via the vent holes 13; and by disposing the partition plate 32, the metal combustion chamber 21 can be isolated to a certain extent, so that influences of heat from the heating rod 22 and the smoking materials on other parts can be reduced as much as possible, and the possibility that particulates drop into a liquid in a cup is reduced.

In an optional embodiment, the holding mesh 23 is provided with a through hole for inserting the heating rod 22. By disposing the through hole, the heating rod 22 is conveniently inserted to the holding mesh 23 and is in contact with the smoking materials.

In the description of the present description, the description with reference to terms “an implementation”, “some implementations”, “an embodiment”, “some embodiments”, “in an optional embodiment”, “specifically”, “example”, “specific example” or “some examples” is intended to indicate that specific features, structures, materials or characteristics described in conjunction with the embodiments or examples are included in at least one embodiment or example of the present invention. In the present description, the schematic statement for the above-mentioned terms does not necessarily refer to the same embodiment or example. Moreover, the described specific features, structures, materials or characteristics may be combined in an appropriate way in any one or more embodiments or examples.

The above-mentioned contents are further detailed descriptions of the present invention in conjunction with the specific implementations, but cannot affirm that the specific implementations of the present invention are only limited to these descriptions. Those of ordinary skill in the art may make several simple derivations or replacements without departing from the concept of the present invention.

What is claimed is:

1. A smoker, characterized by comprising a body, wherein the smoker further comprises a metal combustion chamber disposed in the body, a heating rod mounted in the metal combustion chamber, a holding mesh mounted in the metal combustion chamber and matched with the heating rod for use and a fan mounted on a side, away from the holding mesh, of the metal combustion chamber; and a plurality of vent holes are formed in a side, close to the fan, of the body.

2. The smoker according to claim 1, characterized in that the body is provided with a face plate, and the face plate is provided with a mounting hole matched with the metal combustion chamber for use.

3. The smoker according to claim 2, characterized in that the body is further provided with a cover plate matched with the metal combustion chamber for use.

4. The smoker according to claim 1, characterized in that a control panel for controlling a working state of the smoker and a power module for supplying power for the smoker are further disposed in the body, and the face plate is provided with a button connected with the control panel and used for controlling the fan and the heating rod to be switched on or off.

5. The smoker according to claim 1, characterized in that an LED lamp is further mounted on a side, close to heat dissipation holes, of the fan.

6. The smoker according to claim 1, characterized in that a fixing portion for fixing the metal combustion chamber and the fan is disposed in the body, smoking channels are disposed in the fixing portion, and an accommodating cavity is formed in a space between the fixing portion and the body.

7. The smoker according to claim 1, characterized in that the holding mesh is provided with a through hole for inserting the heating rod.

8. The smoker according to claim 6, characterized in that the fixing portion is provided with a partition plate between the metal combustion chamber and the fan, and a gap communicating with the smoking channels on two sides of the partition plate is disposed around the partition plate.
